(19) United States
(12) Patent Application Publication
(10) Pub. No.: US 2026/0111791 A1
(43) Pub. Date: Apr. 23, 2026

(54) Training Process for Machine Learning Models

(71) Applicant: Varonis Systems Inc., New York, NY (US)

(72) Inventor: Amit Osi, Tel Aviv (IL)

(21) Appl. No.: 18/921,328

(22) Filed: Oct. 21, 2024

(51) Int. Cl. G06N 20/00; G06F 16/93; G06F 18/23213

(52) U.S. Cl. CPC G06N 20/00; G06F 16/93; G06F 18/23213

(57) ABSTRACT

A process for training machine learning models. A model is initially trained using a set of labelled documents, and the trained model is used to predict outputs for a further set of unlabelled documents. A subset of those unlabelled documents is selected, labelled, and utilised in further training of the model.

### TECHNICAL FIELD

The following disclosure relates to a system for training machine learning models, and in particular improved methods of generating training data for training machine learning models.

### BACKGROUND

Machine learning models are typically trained using labelled training data for which the expected output is known. For example, where the machine learning model is being trained to analyse documents, a set of documents are manually labelled by a user with the expected output of the machine learning model. In a simple example, a set of email documents might be labelled as “spam” and “not spam”. These documents and labels are provided to the machine learning model to train it based on the expected outcomes.

The accuracy of training is increased by increasing the size of the training data set. However, labelling documents is a manual process which can take a significant amount of time thus increasing the time and cost of training the machine learning model. The accuracy of machine learning models may therefore be limited by constraints placed on the size of the training data set.

There is therefore a need for an improved labelling system for machine learning models.

### SUMMARY

The invention is defined by the following disclosure and the claims.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding:

FIG. 1 shows a flow chart of a training method, and

FIG. 2 shows an example of a computing device according to the current disclosure.

### DETAILED DESCRIPTION

The present disclosure provides an improved training method for machine learning models by selecting specific documents for labelling to improve model performance.

This disclosure describes a smart sampling methodology for use during training machine learning models. A particular focus is machine learning models used in email security and document classification, but is equally applicable in a wide range of machine learning models. For convenience each member of a training data set will be described as a document, but as will be appreciated this is merely a label which can describe any type of data. For example, “document” may refer to a textual document, emails, pictures, or any other discrete data set.

The disclosure addresses the problem of improving machine learning model training without requiring labelling of an impractical number of documents. After a first round of training has been performed the system selects a second set of documents for labelling from a large unlabelled set of documents. Processes are described for selecting the documents to provide an improved training effect, thereby achieving training while controlling the scale of the labelling exercise.

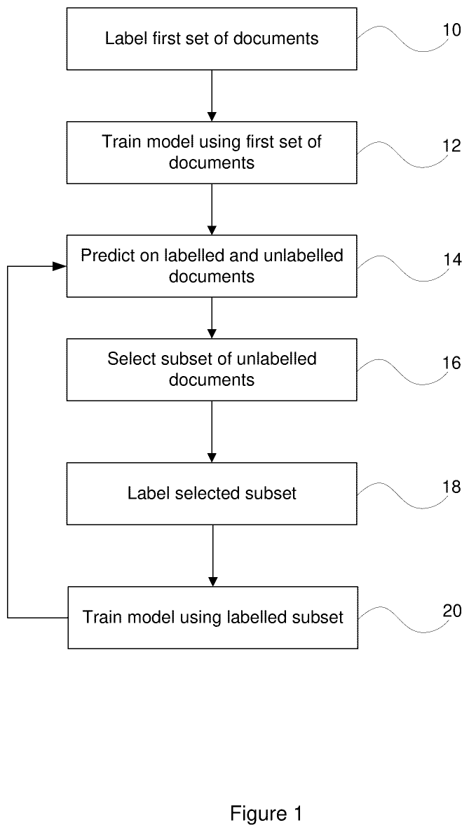

FIG. 1 shows an outline of a method according to the current disclosure. At step 10 a set of documents is labelled to create a first labelled data set, and at step 12 that first labelled data set is used to train the machine learning model.

The method then enters an iterative series of training steps. The number of repetitions can be defined for each model depending on the accuracy required. At step 14 the trained model is run all on available documents (labelled and unlabelled). In a modification of step 14 not all documents may be utilised, for example where there is an extremely large collection of documents. At step 16 the predictions from step 14 are analysed and a subset of the unlabelled documents are selected for labelling at step 18.

The model is then trained further using the newly labelled documents at step 20. If it is deemed the model is sufficiently trained the process can then exit, or if further training is desired the process returns to step 14.

In general better training improvement will be gained from documents where predictions had low confidence (for example between 0.3 and 0.7). That is, documents which the model struggled to categorise into one of two sets as the prediction was close to 0.5 (on a scale of 0 to 1 between the two sets). Documents with predictions outside of this range may be excluded from consideration for labelling as it is unlikely they will have an effect on the quality of training.

Various methods may then be utilised to select which documents to label from the remaining documents, or these methods may be used on the full set of unlabelled documents.

A clustering approach may be utilised to select a representative set of documents. In a first implementation a k-clustering process is utilised to generate clusters of documents. In the clustering approach each document is converted to a numeric vector representation (embedding) using natural language processing techniques, for example using models such as Word2Vec, GloVe, or transformer-based models like BERT. As is known in the field, the embeddings represent the semantic meaning of the processed text. The embedding process could be performed in advance or during the selection process.

The embeddings are then clustered to group semantically-similar documents together into clusters, for example using an algorithm such as k-means or DBSCAN. These algorithms are well known and the following brief description is considered sufficiently to enable implementation in accordance with known techniques. In K-means clustering the dataset is separated into k clusters by minimising the variance within each cluster. The variance can be quantified using a technique such as cosine similarity or Euclidean distance, both of which will be familiar to the skilled reader.

Another approach is DBSCAN (Density-Based Spatial Clustering of Applications with Noise) in which points which are closely packed are grouped, and isolated points in low-density areas are marked as noise. The DBSCAN approach does not require the number of clusters to be pre-decided whereas K-means does.

The number of clusters can be selected based on a number of factors regarding the dataset, requirements and resources. Resources (for example cost, processing capacity, and/or time) may place a limit on the number of documents that can be labelled and hence k can be selected appropriately to provide a suitable number of documents within that limitation. For example, if one document is to be selected per cluster k would be set to the maximum number of documents that can be labelled.

Characteristics of the data may be utilised to determine the preferred number of clusters. For example, the Elbow Method or Silhouette Analysis may be used to determine the optimal number of clusters to ensure broad coverage.

The number of clusters can also be defined iteratively depending on the perform of the model at each iteration.

Once the clusters are formed representative documents are selected from each document for labelling. This can be performed in any known method, for example selection may be based on:
a. Select the document closest to the cluster centroid.
b. Maximising diversity with the cluster.
c. Distance to previously selected documents.

In a further example, to select a set of k documents for labelling, k/2 clusters may be defined, with one document from close to the centre of each cluster, and one additional document (for example an outlier), selected for each cluster. K documents are therefore selected for labelling.

This approach can be generalised to define k as the number of documents to labelled, and t as the number of clusters to create. The number of documents to select from each cluster is therefore k/t. The documents can be selected from each cluster in a way that maximizes coverage within each cluster, for example by selecting documents that are farthest away from each other, or selecting a mixture of typical and atypical documents (central or outlier). The aim of the selection is to give a fair representation of all clusters and to capture the variability across the dataset.

In a further example t clusters are formed and a set of documents is selected from each cluster by starting with a random document and then iteratively selecting additional documents which maximise the distance between them and previously chosen documents.

Each of these examples is intended to select a subset of the documents with a distribution across the unlabelled documents. The expectation is that the distribution of documents achieves improved training performance compared to a random selection, while also reducing the number of documents to be labelled at each iteration. The number of documents selected can be defined based on how accurately it is desired the model to perform, and the resources available for labelling documents and re-training the model.

As is apparent, the process of selecting the subset of unlabelled documents at step 16 can be performed in a wide range of ways, provided the intention is to select a subset which achieves improved training over selecting a random subset. Specific examples are provided herein, but these do not limit the scope of how this step can be performed.

In a variation on this process, documents to be labelled are selected directly as those most likely to improve model accuracy. The trained model is used to predict all (or a subset of) unlabelled documents, and the model's uncertainty for each prediction is calculated using a metric such as entropy sampling (selection of documents where the model's predicted probabilities are closest to uniform, including high uncertainty) or margin sampling (selection of documents where the difference between the top two predicted class probabilities is smallest). Thes selected documents are those that are expected to give the most significant improvement to the model when labelled and used for training.

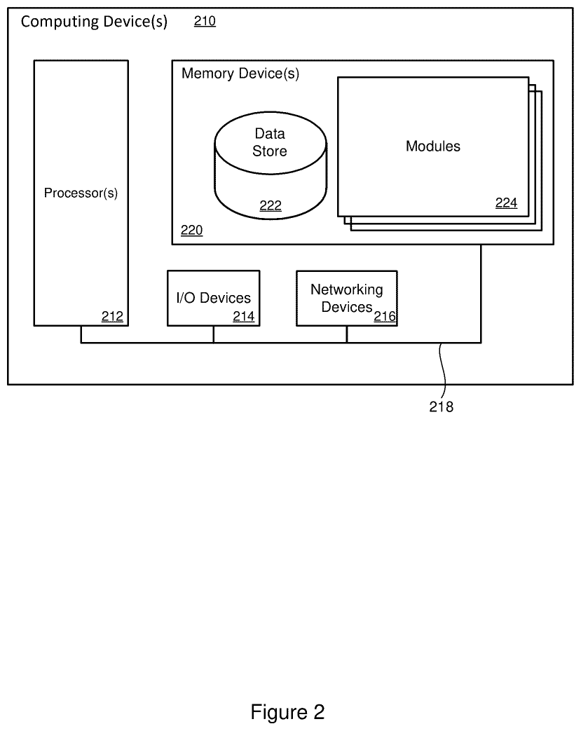

FIG. 2 illustrates a computing device 210 on which modules of this technology may execute. A computing device 210 is illustrated on which a high level example of the technology may be executed. The computing device 210 may include one or more processors 212 that are in communication with memory devices 220. The computing device 210 may include a local communication interface 218 for the components in the computing device. For example, the local communication interface 218 may be a local data bus and/or any related address or control busses as may be desired.

The memory device 220 may contain modules 224 that are executable by the processor(s) 212 and data for the modules 224. In one aspect, the memory device 220 may include a checkpoint manager, a migration management module, and other modules. In another aspect, the memory device 220 may include a network connect module and other modules. The modules 224 may execute the functions described earlier. A data store 222 may also be located in the memory device 220 for storing data related to the modules 224 and other applications along with an operating system that is executable by the processor(s) 212.

Other applications may also be stored in the memory device 220 and may be executable by the processor(s) 212. Components or modules discussed in this description that may be implemented in the form of software using high-level programming languages that are compiled, interpreted or executed using a hybrid of the methods.

The computing device may also have access to I/O (input/output) devices 214 that are usable by the computing devices. Networking devices 218 and similar communication devices may be included in the computing device. The networking devices 218 may be wired or wireless networking devices that connect to the internet, a LAN, WAN, or other computing network.

The components or modules that are shown as being stored in the memory device 220 may be executed by the processor(s) 212. The term “executable” may mean a program file that is in a form that may be executed by a processor 212. For example, a program in a higher level language may be compiled into machine code in a format that may be loaded into a random access portion of the memory device 220 and executed by the processor 212, or source code may be loaded by another executable program and interpreted to generate instructions in a random access portion of the memory to be executed by a processor. The executable program may be stored in any portion or component of the memory device 220. For example, the memory device 220 may be random access memory (RAM), read only memory (ROM), flash memory, a solid state drive, memory card, a hard drive, optical disk, floppy disk, magnetic tape, or any other memory components.

The processor 212 may represent multiple processors and the memory device 220 may represent multiple memory units that operate in parallel to the processing circuits. This may provide parallel processing channels for the processes and data in the system. The local interface 218 may be used as a network to facilitate communication between any of the multiple processors and multiple memories. The local interface 218 may use additional systems designed for coordinating communication such as load balancing, bulk data transfer and similar systems.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognise that various features of the described embodiments may be combined in accordance with the invention. In the claims, the term “comprising” or “including” does not exclude the presence of other elements. Similarly the use of the singular does not exclude the plural and vice-versa.

The term “computer” or “computing device” is used herein to refer to any computing device which can execute software and provide input and output to and from a user. For example, the term computer explicitly includes desktop computers, laptops, terminals, mobile devices, and tablets, as well as any similar or comparable devices. There is no intended difference between the terms computer, computing system or computing device, all of which fall within the same definition of computer.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable storage media or, more generally, a computer program product. The computer readable storage media, as the term is used herein, is not to be construed as storage in the form of transitory signals per se, such as radio waves or other freely propagating electromagnetic waves. The one or more computer readable storage media could be, for example, an electronic, magnetic, optical, electromagnetic, infrared, or semiconductor system, or a propagation medium for data transmission, for example for downloading the code over the Internet. Alternatively, the one or more computer readable storage media could take the form of one or more physical computer readable media such as semiconductor or solid state memory, magnetic tape, a removable computer diskette, a random access memory (RAM), a read-only memory (ROM), a rigid magnetic disc, and an optical disk.

Further disclosure is provided in the following numbered clauses.

1. A computer system for training a machine learning model, comprising: one or more computer readable storage media storing program instructions and one or more processors which, in response to executing the program instructions, are configured to: receive a set of labelled documents; train a machine learning model utilising the set of machine learning documents; operate the machine learning model on a set of unlabelled documents to generate a respective prediction for each document; select a subset of the unlabelled documents on which the machine learning model was operated, the subset being selected based on a probability associated with the prediction for each document; from the selected subset of unlabelled documents selecting a plurality of documents for labelling and labelling those documents; and training the machine learning model using the further set of labelled documents.

2. A computer system according to clause 1, wherein the plurality of documents for labelling are selected using a clustering technique.

3. A computer system according to clause 2, wherein a k-means or DBSCAN technique is utilised.

4. A computer system according to any preceding clause, wherein the probability is the probability is the confidence of the machine learning model in the prediction.

5. A computer system according to clause 4, wherein the confidence is in the range 0.3 to 0.7.

6. A computer system according to clause 1, wherein the plurality of documents for labelling are selected as those most likely to improve the training of the machine learning model.

7. A computer system according to clause 6, wherein documents with least certainty in the prediction are selected.

8. A computer system according to any preceding clause, wherein the steps of operating, selecting a subset, selecting a plurality, and training are repeated iteratively.

9. A computer-implemented method, comprising the steps of: at a computer system comprising one or more computer readable storage media and one or more processors:-receiving a set of labelled documents; training a machine learning model utilising the set of machine learning documents; operating the machine learning model on a set of unlabelled documents to generate a respective prediction for each document; selecting a subset of the unlabelled documents on which the machine learning model was operated, the subset being selected based on a probability associated with the prediction for each document; from the selected subset of unlabelled documents selecting a plurality of documents for labelling and labelling those documents; and training the machine learning model using the further set of labelled documents.

10. A method according to clause 9, wherein the plurality of documents for labelling are selected using a clustering technique.

11. A method according to clause 10, wherein a k-means or DBSCAN technique is utilised.

12. A method according to any of clauses 9 to 11, wherein the probability is the probability is the confidence of the machine learning model in the prediction.

13. A method according to clause 12, wherein the confidence is in the range 0.3 to 0.7.

14. A method according to any of clauses 9 to 13, wherein the plurality of documents for labelling are selected as those most likely to improve the training of the machine learning model.

15. A method according to clause 14 wherein documents with least certainty in the prediction are selected.

16. A method according to any of clauses 9 to 15, wherein the steps of operating, selecting a subset, selecting a plurality, and training are repeated iteratively.

1. A computer system for training a machine learning model, comprising:
one or more computer readable storage media storing program instructions and one or more processors which, in response to executing the program instructions, are configured to:
receive a set of labelled documents;
train a machine learning model utilising the set of machine learning documents;
operate the machine learning model on a set of unlabelled documents to generate a respective prediction for each document;
select a subset of the unlabelled documents on which the machine learning model was operated, the subset being selected based on a probability associated with the prediction for each document;
from the selected subset of unlabelled documents selecting a plurality of documents for labelling and labelling those documents; and
training the machine learning model using the further set of labelled documents.

2. A computer system according to claim 1, wherein the plurality of documents for labelling are selected using a clustering technique.

3. A computer system according to claim 2, wherein a k-means or DBSCAN technique is utilised.

4. A computer system according to claim 1, wherein the probability is the probability is the confidence of the machine learning model in the prediction.

5. A computer system according to claim 4, wherein the confidence is in the range 0.3 to 0.7.

6. A computer system according to claim 1, wherein the plurality of documents for labelling are selected as those most likely to improve the training of the machine learning model.

7. A computer system according to claim 6, wherein documents with least certainty in the prediction are selected.

8. A computer system according to claim 1, wherein the steps of operating, selecting a subset, selecting a plurality, and training are repeated iteratively.

9. A computer-implemented method, comprising the steps of:
at a computer system comprising one or more computer readable storage media and one or more processors:—
receiving a set of labelled documents;
training a machine learning model utilising the set of machine learning documents;
operating the machine learning model on a set of unlabelled documents to generate a respective prediction for each document;
selecting a subset of the unlabelled documents on which the machine learning model was operated, the subset being selected based on a probability associated with the prediction for each document;
from the selected subset of unlabelled documents selecting a plurality of documents for labelling and labelling those documents; and
training the machine learning model using the further set of labelled documents.

10. A method according to claim 9, wherein the plurality of documents for labelling are selected using a clustering technique.

11. A method according to claim 10, wherein a k-means or DBSCAN technique is utilised.

12. A method according to claim 9, wherein the probability is the probability is the confidence of the machine learning model in the prediction.

13. A method according to claim 12, wherein the confidence is in the range 0.3 to 0.7.

14. A method according to claim 9, wherein the plurality of documents for labelling are selected as those most likely to improve the training of the machine learning model.

15. A method according to claim 14 wherein documents with least certainty in the prediction are selected.

16. A method according to claim 9, wherein the steps of operating, selecting a subset, selecting a plurality, and training are repeated iteratively.
